(19) United States
(12) Patent Application Publication
(10) Pub. No.: US 2013/0042518 A1
(43) Pub. Date: Feb. 21, 2013

(54) Portable Live Bait Bucket

(71) Applicant: Kyle Lee Olson, Britt, MN (US)

(72) Inventor: Kyle Lee Olson, Britt, MN (US)

(21) Appl. No.: 13/212,144

(22) Filed: Aug. 17, 2011

(51) Int. Cl. A01K 97/05

(52) U.S. Cl. 43/56

(57) ABSTRACT

A portable live bait bucket with integral handle that has a floatable medium, a thumb grip, partially open top section with no lids, mechanisms or moving parts. The bait bucket is useable in any season and as a storage container to refrigerate unused bait. The container provides ease of mobility, storage, water changing and baits retrieval within a light compact synthetic resinous plastic unit. The bait water can be easily refreshed by sifting stale water through a plurality of holes in the upper chamber and then dipping fresh water from the water surface or submerging into an eight inch ice hole. Changing water is always a one-hand operation. The container is useable on the boat, shore, dock or ice house.

### FIELD OF THE INVENTION

The present invention relates to a portable bait bucket and the construction of the bait bucket for handheld use.

### BACKGROUND OF THE INVENTION

Bait buckets are in use in the fishing industry as floating buckets to be dragged behind a boat or to be placed upon a dock. The bait buckets can be difficult to handle.

### SUMMARY OF THE INVENTION

The present invention solves the problems of handling ease of bait buckets by providing a molded bucket having a thumb tab and handle for easy dipping and handling by a user.

### BRIEF DESCRIPTION OF THE DRAWINGS

FIG. 1 illustrates a bait bucket in accordance with the invention.

FIG. 2 illustrates a front view of the bait bucket of FIG. 1 in accordance with the invention.

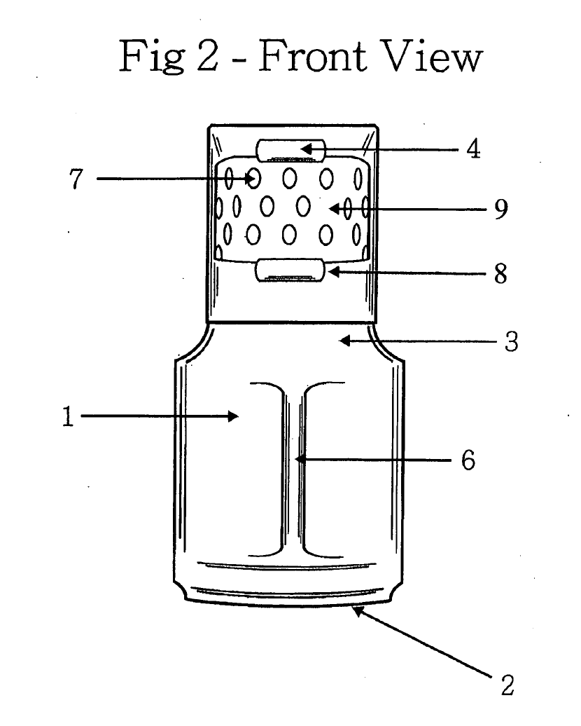

### DETAILED DESCRIPTION

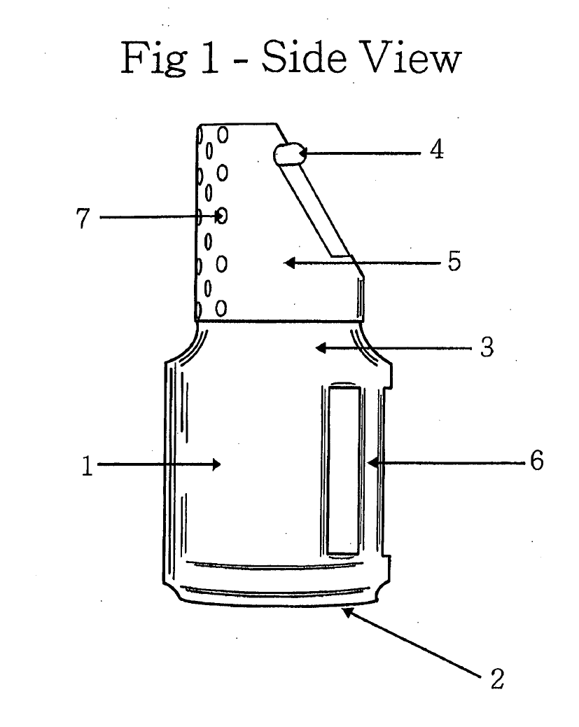

As illustrated in the drawings a bait bucket (1) is shown. In describing the illustrated structure, such expressions as “top”, “bottom” and “side” refer to positions when the bucket is in its vertical configuration as shown in FIG. 1. An integrally molded bucket (1) has a closed base (2), a bottom bucket section (3), an upper bucket section (5) and an upper lip (4). The upper bucket section (5) has a partially open top section (9) preferably extending from the upper lip (4) to a bottom lip comprising a thumb tab or rest (8). The partially open top (9) allows air to easily pass into and through the upper bucket section (5) of the bucket (1). The bucket (1) includes an integral handle (6) and has a plurality of openings (7) on a back side and top side of the upper bucket section (5) for fast replenishment of water and removal of excess water. The openings (7) are provided in any suitable pattern on the top and back sides of the upper bucket section (5) providing that the pattern allows free passage of water. The bucket (1) bottom section (3) is cylindrically shaped or generally polygonal with the integral handle (6) extending from approximately the base (2) to approximately a top end of the bottom section (3). As shown in FIG. 1, a top of the bottom section (3) is preferably curvilinear in shape to merge the bottom section (3) into the upper bucket section (5).

The upper bucket section (5) is preferably cylindrically shaped at its bottom end that abuts the bottom section (3) and tapers to a truncated cone shape at its top end as shown in FIG. 1. Between the bottom and top end of the upper bucket section (5), the partially open top section (9) comprises a cutout in the truncated cone shape of the upper bucket section.

The bucket bottom section (3) including the handle (6) allows a user to dip the bucket into a river, lake or sea with one hand in order to replenish water. The integral handle (6) is configured to contain a floatable medium such as Styrofoam or the like to keep the bucket afloat if dropped into the water. Such floatable mediums as widely used in the bait bucket industry and a selection of a particular floatable medium for inclusion in the handle (6) is selectable. The handle (6) extends along a vertical axis of the bottom section (3) of the bucket (1) allowing a user to grip the handle with the fingers of hand. The thumb rest (8) is configured on the bottom lip of the partially open top section (9) allowing a user to place a thumb thereon whilst gripping the integral handle with the users' fingers in order to easily control the bucket (1) when dipping to replenish water.

The lip (4) on the upper bucket section (5) keeps bait in the bucket and also provides a grip for easy upright transport of the bucket by a user. The lip (4) and thumb rest (8) can be provided with easily grip able material such as foam, rubber or the like allowing the user to grip the bucket when it is wet, such grip able materials are known in the bucket industry and selectable.

A user may place the bucket (1) onto a boat bottom, boat seat, dock or land and replenish water as necessary without having to troll the bucket behind a boat. The water is easily replenished with one hand by manually dipping the bucket into a body of water. The partially open top section (9) allows for an easily visible inspection of bait within bottom section (3) to monitor a need for water replenishment. The bucket (1) easily fits into a refrigerator for extending the bait life and is useable in any season. The bait bucket preferably allows for submersion into an eight inch ice hole for winter water replenishment and can be used in a portable or permanent ice fishing shelter. The bucket can easily be manufactured to smaller or larger dimensions as necessary and for ease of manufacture the bucket is preferably formed integrally by molding from an appropriate synthetic resinous plastic material. The upper section (5) and bottom section (3) may be molded as a continuous structure or each section can be molded separately in relatively simple molds and the two parts joined together by seaming or fastening. The bucket bottom section (3) is preferably blue in color as this seems to calm the bait, but other colors are possible.

The replenishment of the water in the bucket (1) is accomplished solely by water pressure when dipping which forces the bait into the bottom of the bucket preventing an escape of the bait during replenishment. The partially open top allows a user to visibly inspect the bait and therefore stale bait water is easily seen and replenished by dipping.

The present invention thus having been described, it is contemplated that other modifications, alterations or substitutions may suggest themselves to those skilled in the art, all of which are within the spirit and scope of the present invention. It is intended that the present invention be limited only by the scope of the attached claims below.

What is claimed is:

1. A bait bucket comprising;
A bottom bucket section having a closed base for containing bait therein,
an upper section connected to the bottom section, the upper bucket section having a partially open top, the upper section having openings for allowing a passage of water through the openings for replenishment of water, and
an integral handle extending from approximately the closed base to approximately a top of the bottom bucket section.

2. The bait bucket of claim 1 wherein:
the bottom bucket section has a curvilinear top end merging into the upper bucket section.

3. The bait bucket of claim 1 wherein:
a bottom end of the upper bucket section is substantially cylindrical in cross section and the upper bucket section tapers to a truncated cone shape at its upper end, the upper section having a lip for carrying the bucket.

4. The bait bucket of claim 3 wherein:
a partially open top section comprising a cutout is configured in the upper bucket section between the lip and a thumb rest.

5. The bait bucket of claim 4 wherein:
the lip and thumb rest are configured within the truncated cone shape of the upper bucket section.

6. The bait bucket of claim 1 wherein:
the bait bucket bottom section and upper bucket section are integrally molded.

7. The bait bucket of claim 1 wherein:
the integral handle contains floatable material therein.

8. The bait bucket of claim 1 wherein:
the upper bucket section has a lip and a thumb rest.

9. The bait bucket of claim 1 wherein:
the bait bucket is configured to float in water.
